(19) United States
(12) Patent Application Publication
(10) Pub. No.: US 2012/0305421 A1
(43) Pub. Date: Dec. 6, 2012

(54) COST-SAVING METHOD OF MAILING CD, DVD AND OTHER DISCS

(76) Inventor: Daniel SARCEDA, Phoenix, AZ (US)

(21) Appl. No.: 13/487,156

(22) Filed: Jun. 1, 2012

Related U.S. Application Data
(60) Provisional application No. 61/492,330, filed on Jun. 1, 2011.

(51) Int. Cl. B65D 85/57; B31B 1/00; B65B 1/04

(52) U.S. Cl. 206/308.1; 53/467; 493/267

(57) ABSTRACT

Methods of making and using a cost-saving mailer, as well as the inventive mailer are described. To qualify for the lowest-cost, automated mailing of discs (including CD, DVD and similarly sized objects), the mailing system has a mailer of cardboard sized to enclose a standard disc around which the cardboard is folded; and glue is placed in ribbons along the side edges of the cardboard to seal the side edges of the mailer and in two spots to stabilize the disc centrally in the mailer, the two spots being located away from the mailer opening and on either side of the enclosed disc, thereby preventing the disc from moving up and down or side to side after the disc is sealed within the mailer.

### TECHNICAL FIELD

The present invention relates to transport and more particularly to a method of mailing of CDs, DVDs and other discs more economically and safely.

### BACKGROUND

The automated high speed equipment utilized by the postal services and many subcontracted vendors use high tension flexible belts, pulleys, wheels and drums that transport the mail piece around rigid drums and into bins at very high speeds and with high impact. When traveling through the processing equipment, the mailer's leading edge is exposed to most of the impact, as this end is first fed into the equipment and grabbed by friction feeders or belts. Ultimately the leading edge contacts and forcefully stops at the side of its destination sorting bin.

Prior mailers which have been made from thin material or with loose inside sleeve liners have experienced a high percentage of disc breakage due to shifting discs and not enough protection on the leading, trailing and bottom edges. Moreover, other first generation mailers were made from very rigid cardboard stock, usually in a square shape. Such designs prevented the mail piece from successfully running on the automated equipment used by the US Postal Service (USPS) and required special manual handling that delayed delivery and increased costs for the consumer with postage surcharges. These mailers are extremely costly for the USPS because of the expensive and slow manual handling.

To qualify for mailing at the lowest cost with the USPS, a mail piece must meet the qualifications for a letter-sized, automation-compatible mail piece as described by USPS in the Domestic Mail Manual section 201.3.4—Standards for Letter-Size Pieces Containing Discs (CDs or DVD). Revised Apr. 26, 2011.

The USPS standard stipulates that a letter-sized, automation-compatible mailer carrying a single disc measures up to 120 mm (4.7 inches) in diameter and up to 2 mm (0.08 inches) in thickness. When assembled, mailer length is between 18 cm (7.25 inches) and 20 cm (8 inches). The mailer's paper stock must meet the industry standard for a basis weight of 70 pounds or greater.

### SUMMARY OF INVENTION

In one embodiment, there is disclosed an improved method of mailing CDs, DVDs and other discs to obtain a lower cost of mailing. This method has the steps of providing a disc and a mailer. The mailer is a cardboard piece from paper stock with a basis weight of at least 70 pounds. The cardboard piece is diecut in the shape shown in FIG. 1, in that it has sufficient length to fold once around a front and a back of a disc and to provide a flap to fold over the front of the disc, the flap being sized to accommodate a return address and a postage indicia, the cardboard piece being of sufficient width to accommodate the disc and side attachment areas. The mailer also has at least two strips of glue applied to one side of the cardboard in such a way that when the cardboard piece is folded the two strips of glue at least partially seal the sides; and two spots of glue being located away from the mailer opening and on either side of the enclosed discs and equidistant from a centerline of the mailer, thereby preventing the discs from moving up and down or side to side after the discs are sealed within the mailer, and thus stabilizing the disc centrally in the mailer. Further steps including placing the disc in the mailer in a central position and sealing a flap over the disc.

Preferably, the two spots of glue keep the disc from moving more than about one half inch. The center of a spot is located a distance from the flap fold line of about 4.5 inches. The center of a spot is also located a distance from the center line of about 1.9375 inches.

The twice folded cardboard that measures about 5.5 inches to about 6 inches from fold to fold. The mailing system has a width of about 7.25 inches to about 9.75 inches. The mailing system weighs less than about 3.3 ounces.

In another embodiment there is disclosed a mailing system for a disc comprising CD, DVD and similarly sized objects, the mail system qualifying for the lowest cost and automated mailing. The mailing system includes a cardboard piece of paper stock with a basis weight of at least 70 pounds, the cardboard piece being diecut in the shape shown in FIG. 1, of sufficient length to fold once around a front and a back of a disc and to provide a flap to fold over the front of the disc, the flap being sized to accommodate a return address and a postage indicia, the cardboard piece being of sufficient width to accommodate the disc and side attachment areas. The mailing piece has at least two strips of glue applied to one side of the cardboard in such a way that when the cardboard piece is folded the two strips of glue at least partially seal the sides; and two spots of glue being located away from the mailer opening and on either side of the enclosed discs and equidistant from a centerline of the mailer, thereby preventing the discs from moving up and down or side to side after the discs are sealed within the mailer, and thus stabilizing the disc centrally in the mailer.

Preferably, the two spots of glue are so positioned that the inserted disc does not move more than one half inch after the mailer is sealed. The center of the spot is preferably located a distance from the flap fold line of about 4.5 inches. The center of the spot is preferably located a distance from the centerline of the mailer of about 1.9375 inches. The mailing system includes twice folded cardboard that measures from fold to fold about 5.5 inches to about 6 inches. The mailing system has a width of about 7.25 inches to about 9.75 inches. The mailing system weighs less than about 3.3 ounces. Preferably the mailing system has a paper stock has a basis weight of at least 80 pounds.

In yet another embodiment, a method of assembling an improved mailing system is disclosed. The method has the steps of providing a roll of paper stock with a basis weight of at least 70 pounds; printing on one side of the paper boxes for an address for a recipient of the mailer, for a return address of the sender and for postage; cutting the printed paper into approximately rectangular sheets that on one end has a cut-out curve for the front of the mailer; placing glue in two strips for closing the sides of the mailer; placing glue in two spots positioned so as to be inside the corners of the mailer away from the cutout curve; and folding the curved end of the paper sheet over the glue strip and spots, so as to leave the opposite end of the paper exposed and available to fold and cover the cutout curve.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a schematic of the inside of the inventive mailer (before folding) showing the CD, DVD disc place with the new buffer zone around it;

FIG. 2 is a schematic view of the outside of the inventive mailer showing the front or address side view of Panel F (back of panel C) when panel C is folded at fold line 1 onto panel B;

FIG. 3 is a schematic of the front or address side view of Panel F (back of Panel C) when C is folded at fold line 1 into B and when Panel D (back of Panel A) is folded at fold line 2 onto Panel F; and

FIG. 4 is a schematic of the decoration printed side back view of final prepared mailer and Panel E which is the back of inside panel B.

### DETAILED DESCRIPTION

I invented a mailer that allows for increased protection for discs traveling through automated mail sorting and processing equipment. I designed the disc mailer to better protect the disc by imparting added strength across both disc sides and added protection as the disc bends around the drums. My new mailer improves disc protection because it hugs both sides of the disc and flexes with the disc as the disc-in-mailer bends around the drums. The mailer material or cardboard paper stock bends in unison with the inside disc and forms a glove-like bond with the inside disc. Importantly, the disc cannot move or shift inside the mailer due to the restrictive disc-holding feature inside the mailer and top edge, thereby forming a protective jacket on the front and the back of the disc. The paper cardboard material contacting the disc's front and back does not wrinkle or fold (unlike light-weight TYVEK® mailers) due to the restrictive movement formed by the inside disc holding spots and the glued top seal flap. The areas around the outer diameter edge of the disc bend freely as needed and absorb the shock on the leading and trailing edge of the mailer. The bottom edge of the mail piece has a buffer area separating the disc from the bottom edge of the mailer. The mailer's top edge also provides another layer of built-in protection when the top flap is folded over and sealed.

Another embodiment includes but is not limited to any form of disc-holding feature utilizing a bonding agent applied inside a mailer to secure a disc in a position approximately symmetrical to the center of the mailer and as near to the top edge of the constructed mailer as is practical.

Another embodiment of the inventive mailer is constructed from any paper stock which meets the qualifications for a letter-sized, automation-compatible mail piece as described by The US Postal Service (USPS) in the Domestic Mail Manual section 201.3.4—Standards for Letter-Size Pieces Containing Discs (CDs or DVD). At least 70-pound paper is required. Preferred in the present invention is paper stock of at least 80-100 pounds. More preferred is paper stock of about 80 pounds.

The inventive mailer measures up to 120 mm (4.7 inches) in diameter and up to 2 mm (0.08 inch) in thickness.

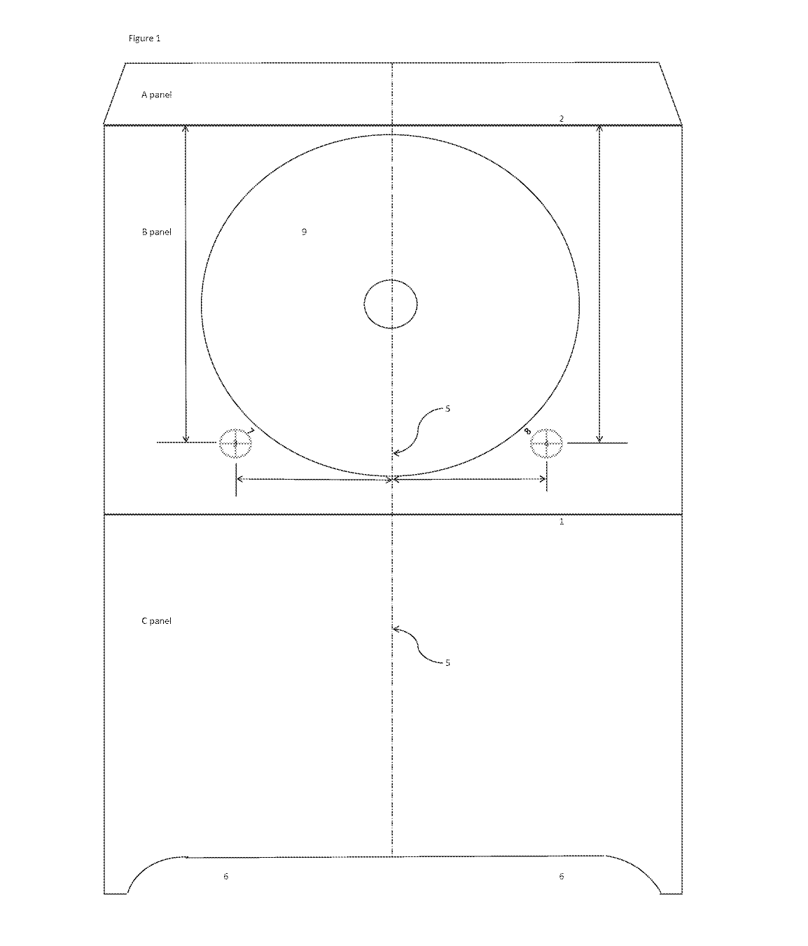

FIG. 1 shows a schematic layout of the inside of the inventive mailer 30. Starting at the top, there is the A panel designed to fold over at fold line 2 for sealing the mailer. The B panel when folded along fold line 1 will be the back of the mailer. The C panel will be the inside of the front of the mailer after the cardboard is folded along fold line 1. The B panel has circles 3 and 4 for glue deposits which hold the disc in disc area 9 which is centered at center line 5. Because the cardboard mailer will not allow a disc to touch the glue spots 3 and 4, the glue spots 3 and 4 and cardboard together create buffer zones 7 and 8 that further protect the inserted disc and limit its movement in the mailer.

The C panel is preferably curved for disc opening 6. This curved opening 6 makes it easier to slip CDs or other types of discs into the assembled mailer. On either side of the curve, the sides extend to provide greater strength at the two corners. The curved opening 6 where cardboard is missing is reinforced when the A panel is folded over for sealing and mailing. The B panel includes a disc-holding feature such that when the disc is inserted and sealed into the mailer, the disc-holding feature positions and secures the disc center near the vertical centerline 5 and as near to the top edge of fold line 2 of the mail piece as is practical, as illustrated in FIG. 1.

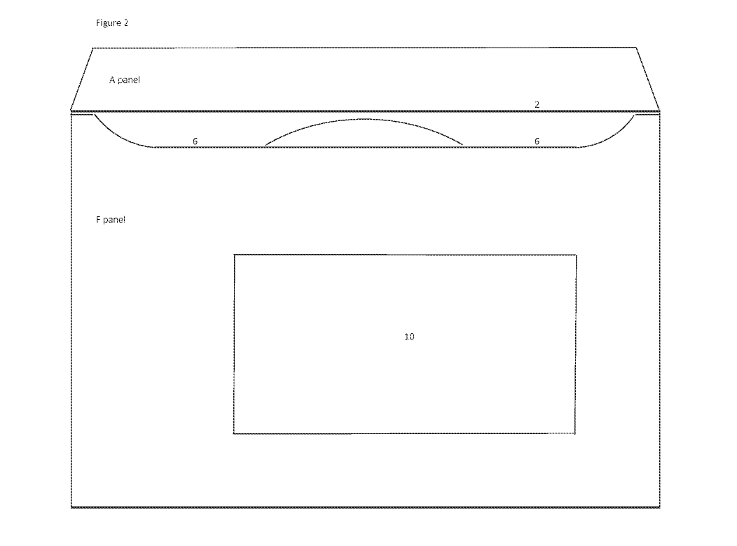

FIG. 2 shows the embodiment of FIG. 1 after assembled for commercial use. Still visible is the A panel which is the last to be folded over on fold line 2. Now visible is the F panel, which is the reverse of C panel. Preferably the F panel is printed with a rectangle 10 in which the user places a barcoded address. FIG. 2 also shows the location of the inserted disc 30 which is centered in the mailer due to the glue points (FIG. 1).

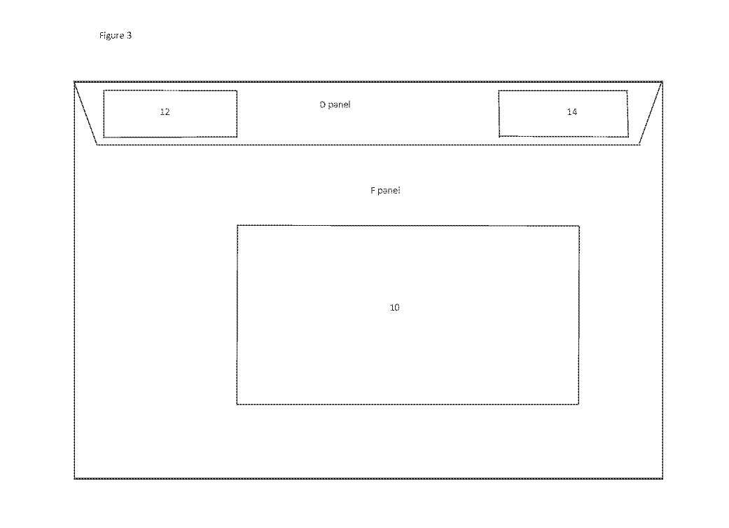

FIG. 3 shows the embodiment of FIGS. 1 and 2, after the top flap has been closed onto the F panel to show the flap's D panel, which is the back of the A panel shown in the previous figures. The D panel is preferably printed with a return address box 12 and a postage box 14.

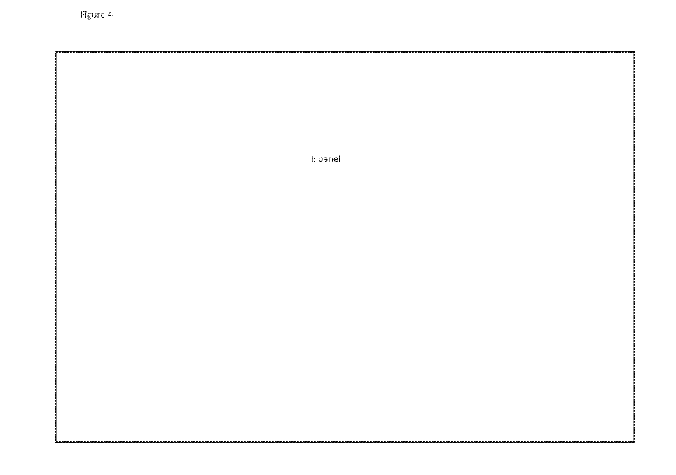

FIG. 4 shows the back of the mailer, or the E panel. In one embodiment, Panel E is utilized for print decoration or messages, such as advertising for the manufacturer, the mailing concern or public service messages (when sold by the USPS).

One way to manufacture the inventive mailer is provided herein, with the stipulation that the method can be adapted as needed for high-speed production. When print is desired for one or both sides, the commercial paper roll of cardboard stock can first be printed with the messages, as desired. For example, one side was printed with the return address box 12 and postage box 14 (D panel) and the outgoing address box 10 (F panel). Optionally, the second side is printed with at least the circles for the glue spots 3 and 4, which is advantageous when the glue spots are placed by hand, or optionally with fold lines 1 and 2. Then the cardboard is cut to produce the shape shown in FIG. 1. Preferably diecutting is used, as it provides clean edges. Glue lines are placed on the sides of the mailer on either the D or C panel, and two glue spots are added to position the disc centrally. Panels B and C are folded together along the fold line 1 into the assembly shown in FIG. 2. The mailer so assembled and dried is ready for sale.

The purchaser of the mailer then inserts the disc 30 as shown in FIG. 2. The disc 30 was inserted into the disc opening 6 between panels C and B in a top to bottom motion as shown in FIG. 2. The disc is pushed into mailer from top to bottom until the disc meets and stops at the disc stops (glue spots 3 and 4) inside the mailer and moves past the top fold line 2 for full insertion into the mailer where it is held stationary in the fixed disc location 9 (FIG. 1). If the disc 30 does not fully insert and permit closure of the top flap, the disc stoppers may not have been properly located.

I took great pains to get the location and amount of glue to the exact position to limit movement of the disc to less than ½ inch in any direction, as required by US Postal Service's Domestic Mail Manual section 201.3.4.2—Disc Size and Placement

The inventive mailer has a disc-holding feature that utilizes a bonding agent such as glue, tape (such as two sided tape) or other materials in use as bonding agents. When bonding agent is placed in locations 3 and 4 on panel B as shown in FIG. 1, and when panel C is folded onto panel B at fold line 1, the bonding agent causes panels C and B to permanently bond together; this creates a disc-stop point which will not allow the disc, when inserted from the top of mailer, to move past the area above or to either side of the bonding agent.

This embodiment of the disc-stop feature shows the preferred placement for bonding spots 3 and 4 in FIG. 1. The exact placement of the bonding agent is ultimately determined by the final spread of the bonding agent used when panels C and B are folded and pressed together. The preferred bonding spot placement described above takes into account a possible glue spread of about 1 cm (about 0.5 inch) from the center of bonding spot placement. The edge of the bonding agent when spread should not encroach into the buffer zone 7 which could restrict interior space and not allow the disc to be fully inserted into the mailer. For larger glue spreads, the center of the bonding spot is moved farther from the center of the disc.

This embodiment of the disc stop feature indicates the ideal bonding spot placement for the two spots 3 and 4 in FIG. 1. On the each side of centerline 5 on panel B, bonding spots 3 and 4 are located at intersecting points that extend perpendicularly from the ends of 1) a line from fold line 2 measuring 11.4 cm (4.5 inches), and 2) a line perpendicular from center line 5 measuring 4.9 cm (1.9375), extending on either side of center line 5 as shown in FIG. 1. The exact placement of the bonding agent is ultimately determined by the final spread of the bonding agent used when panels C and B are folded and pressed together. The preferred bonding spot placement described above takes into account a glue spread of about 1 cm (about 0.5 inch) from center of bonding spot placement. If the spread of the desired glue is greater, then the two glue spots are moved diagonally toward the corners, as appropriate. The edge of the bonding agent when spread should not encroach into the buffer area 8 which could restrict interior space and not allow the disc to be fully inserted into the mailer.

In addition to the above preferred bonding spot placement described above, this embodiment provides for internal placement of any type of bonding agent for the purpose of securing a disc into the position symmetrical to the center and as high to the top as practical.

This embodiment is a mailer that when folded, glued and assembled with disc inserted into mailer and sealed, is rectangular in shape and has an aspect ratio of 1.3 or greater when the length is divided by the height.

The preferred height measured on the left or right edge (and perpendicular to the address lines) of the fully assembled, sealed mailer, is no less than about 14 cm (5.5 inches) and no greater than about 15 cm (6 inches), for a range of about 14 cm to about 15 cm.

The preferred length measured on the top or bottom edge (and parallel to the address lines) of the fully assembled and sealed mailer (FIG. 4) from left to right edge, is no less than about 18.4 cm (7.25 inches) and no greater than about 24.8 cm (9.75 inches). More preferably the length of the assembled mailer is between about 18.4 cm (7.25 inches) and no greater than about 20.3 cm (8 inches).

The preferred thickness of the mailer when laid flat and when fully assembled with disc therein and sealed does not exceed about 0.6 cm (0.25 inches).

The preferred total weight of a single mailer with disc when fully assembled, sealed and prepared for mailing is less than or equal to about 3.3 ounces. Less weight is preferred for mailing fees, but must be balanced against the strength of the cardboard.

The preferred paper stock meeting the industry standard for a basis weight of 70 pounds or greater. More preferred is paper stock with a basis weight of 80 pounds or greater.

After disc is fully inserted and has moved past fold line 2 between panels B and C into its fixed position 9 inside mailer, Panel A is then folded at fold line 2 and sealed with a bonding agent onto panel F which is the reverse side of Panel C, as shown in FIG. 3.

In another embodiment, Panel E is utilized for print decoration as shown in FIG. 4.

In yet another embodiment, Panel D is used for return address information and postage information as shown in FIG. 3.

Alternately, Panel F accepts destination addresses as shown in FIG. 3.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

1. An improved method of mailing CDs, DVDs and other discs to obtain a lower cost of mailing, the method comprising
a) providing a disc;
b) providing a mailer comprising
i. a cardboard piece comprising paper stock with a basis weight of at least 70 pounds, the cardboard piece being diecut in the shape shown in FIG. 1, of sufficient length to fold once around a front and a back of a disc and to provide a flap to fold over the front of the disc, the flap being sized to accommodate a return address and a postage indicia, the cardboard piece being of sufficient width to accommodate the disc and side attachment areas;
ii. at least two strips of glue applied to one side of the cardboard in such a way that when the cardboard piece is folded the two strips of glue at least partially seal the sides; and
iii. two spots of glue being located away from the mailer opening and on either side of the enclosed discs and equidistant from a centerline of the mailer, thereby preventing the discs from moving up and down or side to side after the discs are sealed within the mailer, and thus stabilizing the disc centrally in the mailer.
c) placing the disc in the mailer in a central position; and
d) sealing a flap over the disc.

2. The method of claim 1 wherein the location of the two spots of glue keep the disc from moving more than about one half inch.

3. The method of claim 2 further comprising a center of a spot being located a distance from the flap fold line of about 4.5 inches.

4. The method of claim 1 further comprising a center of a spot being located a distance from the center line of about 1.9375 inches.

5. The method of claim 1 further comprising twice folded cardboard that measures about 5.5 inches to about 6 inches from fold to fold.

6. The method of claim 1 wherein the mailing system has a width of about 7.25 inches to about 9.75 inches.

7. The method of claim 1 wherein the mailing system weights less than about 3.3 ounces.

8. A mailing system for a disc comprising CD, DVD and similarly sized objects, the mail system qualifying for the lowest cost and automated mailing, the mailing system comprising a mailer comprising
a) a cardboard piece comprising paper stock with a basis weight of at least 70 pounds, the cardboard piece being diecut in the shape shown in FIG. 1, of sufficient length to fold once around a front and a back of a disc and to provide a flap to fold over the front of the disc, the flap being sized to accommodate a return address and a postage indicia, the cardboard piece being of sufficient width to accommodate the disc and side attachment areas;
b) at least two strips of glue applied to one side of the cardboard in such a way that when the cardboard piece is folded the two strips of glue at least partially seal the sides; and
c) two spots of glue being located away from the mailer opening and on either side of the enclosed discs and equidistant from a centerline of the mailer, thereby preventing the discs from moving up and down or side to side after the discs are sealed within the mailer, and thus stabilizing the disc centrally in the mailer.

9. The mailing system of claim 8 further comprising positioning the two spots of glue so that the inserted disc does not move more than one half inch after the mailer is sealed.

10. The mailing system of claim 8 further comprising the center of the spot being located a distance from the flap fold line of about 4.5 inches.

11. The mailing system of claim 8 further comprising the center of the spot being located a distance from the centerline of the mailer of about 1.9375 inches.

12. The mailing system of claim 8 further comprising twice folded cardboard that measures from fold to fold about 5.5 inches to about 6 inches.

13. The mailing system of claim 8 wherein the mailing system has a width of about 7.25 inches to about 9.75 inches.

14. The mailing system of claim 8 wherein the mailing system weighs less than about 3.3 ounces.

15. The mailing system of claim 8, wherein the paper stock has a basis weight of at least 80 pounds.

16. A method of assembling an improved mailing system, the method comprising
a) providing a roll of paper stock with a basis weight of at least 70 pounds;
b) printing on one side of the paper boxes for an address for a recipient of the mailer, for a return address of the sender and for postage;
c) cutting the printed paper into approximately rectangular sheets that on one end has a cut-out curve for the front of the mailer;
d) placing glue in two strips for closing the sides of the mailer;
e) placing glue in two spots positioned so as to be inside the corners of the mailer away from the cutout curve; and
f) folding the curved end of the paper sheet over the glue strip and spots, so as to leave the opposite end of the paper exposed and available to fold and cover the cutout curve.

17. The method of assembling an improved mailer of claim 16, further comprising positioning the two spots of glue so that the inserted disc does not move more than one half inch after the mailer is sealed.

18. The method of assembling an improved mailer of claim 16, further comprising the center of the spot being located a distance from the flap fold line of about 4.5 inches.

19. The method of assembling an improved mailer of claim 16, further comprising the center of the spot being located a distance from the centerline of the mailer of about 1.9375 inches.

20. The method of assembling an improved mailer of claim 16, further comprising twice folded cardboard that measures from fold to fold about 5.5 inches to about 6 inches.

21. The method of assembling an improved mailer of claim 16, wherein the mailing system has a width of about 7.25 inches to about 9.75 inches.

22. The method of assembling an improved mailer of claim 16, wherein the mailing system weighs less than about 3.3 ounces.
